(19) United States
(12) Patent Application Publication
(10) Pub. No.: US 2006/0210239 A1
(43) Pub. Date: Sep. 21, 2006

(54) Method for transferring video material, transmission side apparatus for transferring video material and reception side apparatus for transferring video material

(75) Inventors: Makoto Honda, Kokubunji-shi (JP); Hiroyuki Takahashi, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/373,137

(22) Filed: Mar. 13, 2006

(30) Foreign Application Priority Data
Mar. 18, 2005 (JP) 2005-079652

(51) Int. Cl. H04N 5/93

(52) U.S. Cl. 386/52

(57) ABSTRACT

A transmission side apparatus reads out editing information from a storage unit in accordance with a name of an editing material and grasps time positions of a start frame and an end frame. The apparatus reads out an original material from a storage unit, determines a GOP including a cutting-out start frame as a head GOP and a GOP including a cutting-out end frame as an end GOP to cuts out the editing material while including both GOPs. The apparatus converts the start frame of the editing information into the number of frames from a head of the head GOP and the end frame thereof into the number of frames from a head of the end GOP to store the numbers. The apparatus transfers an editing material created in this manner to a reception side apparatus in a format of MPEG 2 Long-GOP data together with the editing information.

### CROSS-REFERENCE TO RELATED APPLICATIONS

This application is based upon and claims the benefit of priority from prior Japanese Patent Application No. 2005-079652, filed Mar. 18, 2005, the entire contents of which are incorporated herein by reference.

### BACKGROUND OF THE INVENTION

1. Field of the Invention

The present invention relates to a method for transferring a video material, a transmission side apparatus for transferring the video material and a reception side apparatus for transferring the video material so that a video recording/reproducing apparatus on a reception side can reproduce a video virtual editing result obtained by reproducing only a part of a video material through a video recording/reproducing apparatus on a transmission side by using editing information.

2. Description of the Related Art

Conventionally, in a video information processing apparatus, a ‘virtual editing function’ of reproducing only a part of an original recording video material (hereinafter referred to as recording material) by using work information in editing (hereinafter referred to as editing information) in advance has been widely used. When both video recording/reproducing apparatus on the transmission side and video reproducing/reproducing apparatus on the reception side are apparatuses using video compression techniques of MPEG 2 Long-GOP system and they have the virtual editing functions, respectively, there are the following methods in which a transmission side apparatus edits the recording material edited by the virtual editing function and transfers it to a reception side apparatus to reproduce it.

(1) The transmission side apparatus cuts out the recording material on MPEG 2 data on the basis of the editing information to transfer only the cut out MPEG 2 data to the reception side apparatus.

(2) The transmission side apparatus transfers both recording material and editing information and the reception side apparatus virtually edits the recording material by using the editing information.

(3) The transmission side apparatus decodes to reproduce only a part of the recording material on the basis of the editing information and the reception side apparatus records the reproduced video.

However, in the method (1), reconstruction processing of an MPEG 2 long-GOP is required. Since this processing needs a complicated calculation, a hardware load of the transmission side apparatus is increased. In the method (2), since parts not needed for a reproduction are transferred all together, a transfer quantity of the MPEG 2 data and a usage quantity of recording media are increased in comparison to the method (1). In the method (3), since the video information processing apparatus treats the MPEG 2 data thorough expansion/compression processing, it deteriorates the image quality of the reproduced video in comparison to other methods.

An example of a video signal transfer technique is disclosed in Jpn. Pat. Appln. KOKAI Publication No. 11-225127.

### BRIEF SUMMARY OF THE INVENTION

An object of the present invention is to provide a method for transferring a video material, a transmission side apparatus for transferring a video material and a reception side apparatus for transferring a video material which can efficiently transfer a video material edited by the transmission side apparatus by using a ‘virtual editing function’ with a minimum capacity and without deteriorating a video quality to the reception side apparatus.

The method for transferring the video material regarding the present invention, cutting out an arbitrary range of a video material compressed and processed in an MPEG long-GOP system with frame precision and transferring the cut out material, stores a time position of a start frame and a time position of an end frame in cutting out to edit the video material, respectively, as editing information, determines GOP including a cutting-out start frame of the editing information as a head GOP, determines a GOP including a cutting-out end frame as an end GOP, cuts out a range from the head GOP to the end GOP, converts the start frame of the editing information into the number of frames from a head of the head GOP, converts the end frame of the editing information into the number of frames from a head of the end GOP, and transfers the cut out material together with the editing information.

The transmission side apparatus for transferring the video material regarding the present invention, cutting out an arbitrary range of a video material compressed and processed in an MPEG long-GOP system with frame precision and transferring the cut out material, comprises an unit to store a time position of a start frame and a time position of an end frame in cutting out and editing the video material, respectively, as editing information, and an unit to determine GOP including a cutting-out start frame of the editing information as a head GOP, to determine a GOP including a cutting-out end frame as an end GOP, to cut out a range from the head GOP to the end GOP, to convert the start frame of the editing information into the number of frames from a head of the head GOP, to convert the end frame of the editing information into the number of frames from a head of the end GOP, and to transfer the cut out material together with the editing information in response to a transfer instruction.

The reception side apparatus for transferring the video material regarding the present invention, cutting out an arbitrary range of a video material compressed and processed in an MPEG long-GOP system with frame precision and transferring the cut out material, when storing a time position of a start frame and a time position of an end frame in cutting out and editing the video material, respectively, as editing information, determining GOP including a cutting-out start frame of the editing information as a head GOP, determining a GOP including a cutting-out end frame as an end GOP, cutting out a range from the head GOP to the end GOP, converting the start frame of the editing information into the number of frames from a head of the head GOP, converting the end frame of the editing information into the number of frames from a head of the end GOP, and transferring the cut out material together with the editing information in response to a transfer instruction, comprises a material storage unit to store the cut out material, an editing information storage unit to store the editing information and a virtual editing unit to edit virtually the cut out material on the basis of the editing information.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram showing a configuration of a video recording/reproducing apparatus having a virtual editing function used for the present invention and showing an operation example of the editing function;

FIG. 2 is an exemplary block diagram showing a configuration of a video material transfer system to which a method for transferring a video material regarding the present invention is applied and showing an operation example of the system configuration; and

FIG. 3 is an exemplary flowchart showing a flow of concrete processing of a transmission side apparatus when the method regarding the present invention is applied.

### DETAILED DESCRIPTION OF THE INVENTION

Hereinafter, embodiments of the present invention will be described in detail by referring to the drawings.

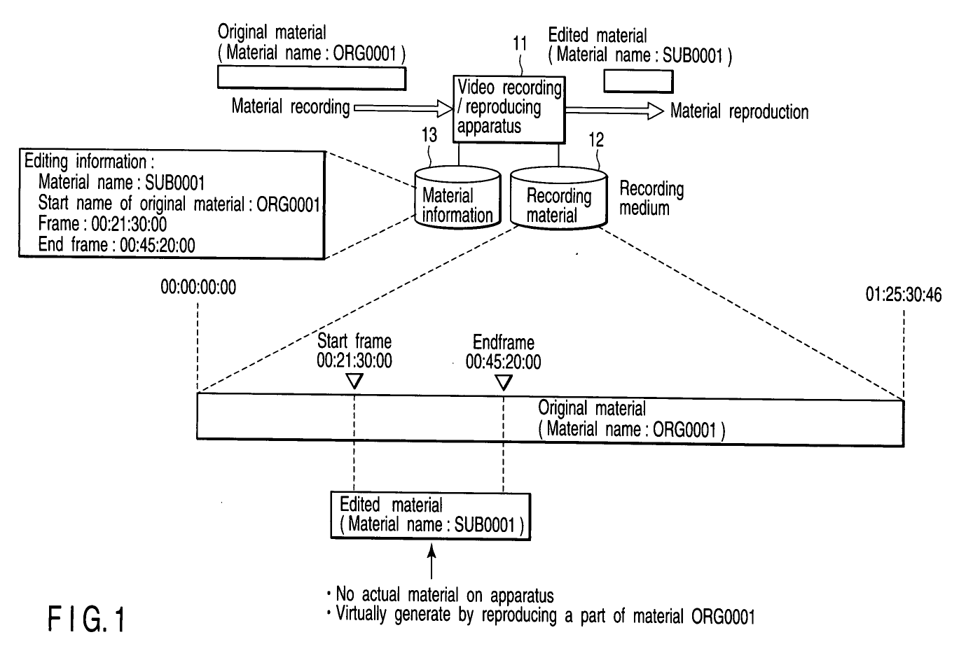

Referring first to FIG. 1, an operation example of a virtual editing function will be described. In FIG. 1, a video recording/reproducing apparatus 11 has the virtual editing function. The recording/reproducing apparatus 11 has a recording medium such as a memory bank device and a hard disk device, and the recording medium secures areas for a recording material storage unit 12 and a material information storage unit 13 therein. Here, it is assumed that the recording/reproducing apparatus 11 treats MPEG 2 long-GOP data (GOP: 15 frames) as the recording material.

When being input an original recording video material (hereinafter referred to as original material: material name ORG 0001) in material recording, the recording/reproducing apparatus 11 stores the original material in the material storage unit 12 and reads out material information added to the original material to store it to the information storage unit 13.

The editing function specifies a start frame (00:21:30:00) and an end frame (00:45:20:00) of a cut put part to the original material (material name ORG 0001: head frame 00:00:00:00, end frame 01:25:30:46) to specify a range of an editing material. A material name (SUB 0001 in FIG. 1) is newly added to the editing material. The information storage unit 13 stores information about the material name, start frame and end frame (00:21:30:00, 00:45:20:00) as the editing information.

When reproducing a virtual editing result, the recording/reproducing apparatus 11 reads out to reproduce the editing material from the start frame of the original material stored in the material storage unit 12 on the basis of the editing information stored in the information storage unit 13 and terminates reading-out at the end frame. In this way, in virtual editing, the recording/reproducing apparatus 11 has no actual material thereon and generates the editing material virtually by reproducing a part of the original material ORG 0001.

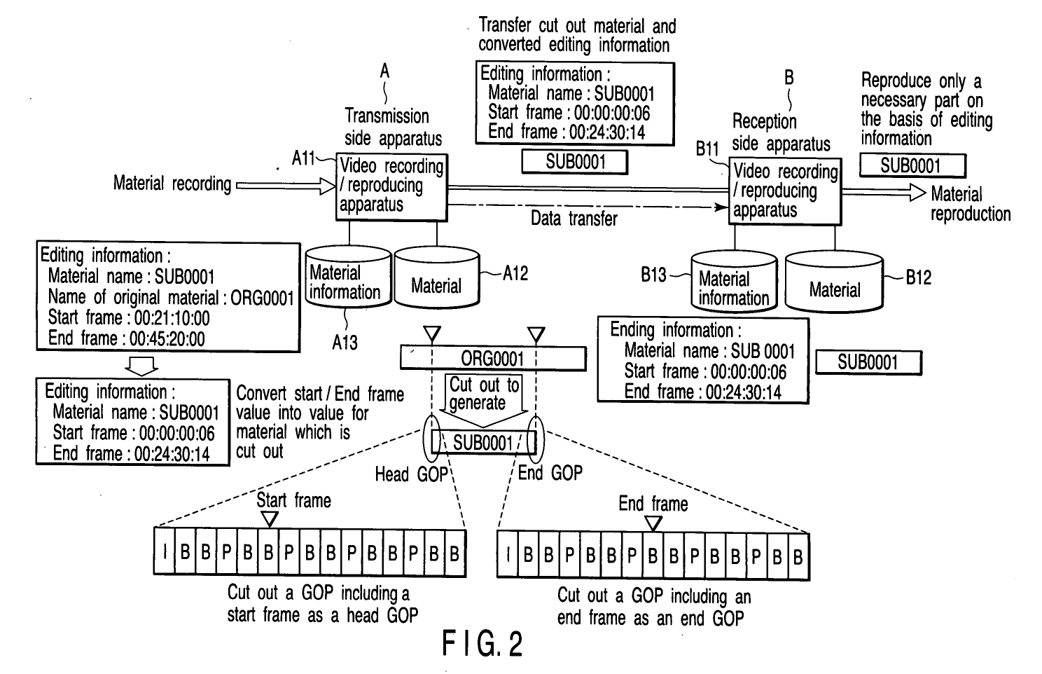

The case of transfer of the editing material between video recording/reproducing apparatuses respectively having the above-mentioned virtual editing functions in the embodiment of the present invention will be explained with reference to FIG. 2. Here, the embodiment utilizes a property that the MPEG 2 Long-GOP data which is the recording material is simple in data cutting-out processing by GOP unit and light in hardware load.

In FIG. 2, both transmission side apparatus A and reception side apparatus B equivalent to the video recording/reproducing apparatus 11 having the virtual editing function and being shown in FIG. 1. It is assumed that the transmission side apparatus All stores the original material ORG 0001 in a material storage unit A12 and stores editing information of a material named SUB 0001, namely, time positions of the start frame and end frame.

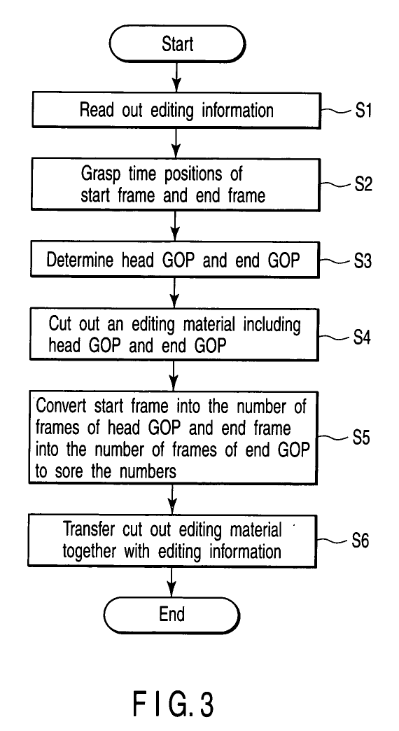

When receiving a transfer instruction for the editing material named SUB 0001, the transmission side apparatus A performs processing in accordance with procedures shown in FIG. 3. At first, the transmission side apparatus A reads out the corresponding editing information from the editing material named SUB 0001 of which the transfer is instructed (S1) and grasps the time positions of the start and end frames (S2). At this moment, the transmission side apparatus A determines GOP including a cutting-out start frame as a head GOP and GOP including a cutting-out end frame as an end GOP (S3) and reads out the original material ORG 001 from the material storage unit A12 to cut out the editing material (S4) so as to include both GOPs. The transmission side apparatus A converts the start frame of the editing information into the number of frames from a head of a head GOP and the end frame thereof into the number of frames from a head frame of an end GOP to store them (S5). The editing material SUB 0001 created in this manner is transferred to the reception side apparatus B together with the editing information in a format of the MPEG 2 Long-GOP data (S6).

The reception side apparatus B stores the editing material SUB 0001 in a recording material storage unit B12 and stores the editing information in an editing information storage unit B13. Thereby, the reception side apparatus B can reproduce the editing material SUB 0001 from a specified frame in the head GOP to a specified frame in the end GOP.

In this case, since the virtual editing function can transfer a GOP structure together with the editing material to start the reproduction from the specified frame of the head GOP by means of the reception side apparatus B, it does not need reconstruction processing of the MPEG 2 long-GOP on the transmission side apparatus and it hardly affects on the hardware of the transmission side apparatus A. Since the editing function does not transfer a part which is not necessary for the reproduction, it can reduce the load applied to a transfer quantity of MPEG 2 data and a usage quantity of recording a recording medium. Further, since it does not need to perform expansion/compression processing of the MPEG 2 data for its transfer, it can transfer the data while maintaining its video quality and achieve an excellent video reproduction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for transferring a video material, cutting out an arbitrary range of a video material compressed and processed in an MPEG long-GOP system with frame precision and transferring the cut out material, the method comprising:
storing a time position of a start frame and a time position of an end frame in cutting out to edit the video material, respectively, as editing information; and
determining GOP which includes a cutting-out start frame of the editing information as a head GOP, determining a GOP which includes a cutting-out end frame of the editing information as an end GOP, cutting out a range from the head GOP to the end GOP, converting the start frame of the editing information into the number of frames from a head of the head GOP, converting the end frame of the editing information into the number of frames from a head of the end GOP, and transferring the cut out material together with the editing information.

2. A transmission side apparatus for transferring a video material, cutting out an arbitrary range of a video material compressed and processed in an MPEG long-GOP system with frame precision and transferring the cut out material, the apparatus comprising:
an unit to store a time position of a start frame and a time position of an end frame in cutting out to edit the video material, respectively, as editing information; and
an unit to determine GOP including a cutting-out start frame of the editing information as a head GOP, to determine a GOP including a cutting-out end frame as an end GOP, to cut out a range from the head GOP to the end GOP, to convert the start frame of the editing information into the number of frames from a head of the head GOP, to convert the end frame of the editing information into the number of frames from a head of the end GOP, and to transfer the cut out material together with the editing information in response to a transfer instruction.

3. A reception side apparatus for transferring a video material, cutting out an arbitrary range of a video material compressed and processed in an MPEG long-GOP system with frame precision and transferring the cut out material, when storing a time position of a start frame and a time position of an end frame in cutting out to edit the video material, respectively, as editing information, determining GOP including a cutting-out start frame of the editing information as a head GOP, determining a GOP including a cutting-out end frame as an end GOP, cutting out a range from the head GOP to the end GOP, converting the start frame of the editing information into the number of frames from a head of the head GOP, converting the end frame of the editing information into the number of frames from a head of the end GOP, and transferring the cut out material together with the editing information in response to a transfer instruction, the apparatus comprising:
a material storage unit to store the cut out material;
an editing information storage unit to store the editing information; and
a virtual editing unit to edit virtually the cut out material on the basis of the editing information in reproducing the cut out material.
